(19) United States
(12) Patent Application Publication
(10) Pub. No.: US 2011/0192037 A1
(43) Pub. Date: Aug. 11, 2011

(54) Cooking spoon

(76) Inventor: Louis F. Genatossio, Shrewsbury, MA (US)

(21) Appl. No.: 12/658,505

(22) Filed: Feb. 10, 2010

(51) Int. Cl. A47J 43/28

(52) U.S. Cl. 30/327

(57) ABSTRACT

A spoon 2 including a bowl 22 having a top end 8, first and second curved longitudinal sides 12, 10, a flat bottom end 14 formed integrally with the bowl 22, and a handle 6 attached to the top end 8 of the bowl 22. The bowl 22 merges with the flat bottom end 14 and provides a receptacle for material directed thereinto by the flat bottom 14. In addition, the profile of the interface 18 between the first longitudinal side 12 and the bottom end 14 is curved and the profile of the interface 20 between the second longitudinal side 10 and the bottom end 14 is squared.

### BACKGROUND OF THE INVENTION

1. Field of the Invention

The invention relates generally to cooking spoons. More particularly, the invention relates to spoons usable to scrape cooking surfaces, stir and scoop dense ingredients, and measure quantities of ingredients.

2. Description of the Prior Art

Different utensils are used in cooking to perform different functions. For example, a measuring spoon is often used to measure quantities of ingredients in a mixing bowl. Thereafter, a mixing spoon is often used to mix the ingredients, or to transfer the mixed ingredients to a baking pan or other container. Upon transfer of the mixed ingredients, a spatula is often used to scrape the walls and rim of the mixing bowl to ensure that all of the ingredients are removed therefrom.

The use of multiple utensils to perform different tasks while cooking adds complexity to the cooking task. For example, the cleanup and storage of many utensils is inconvenient and time-consuming. In addition, while cooking it is often desirable to perform different tasks, such as combining and then mixing ingredients, in rapid succession. The necessity of changing utensils between tasks (e.g., from a measuring spoon to a spatula) is inefficient and may slow the execution of steps in a cooking operation.

Some prior art kitchen spoons have attempted to address these problems. For example, one embodiment of the spoon of U.S. Pat. No. 4,524,513 has a straight front edge that serves as a scraper for scraping cooking surfaces. While this spoon attempts to provide improvements over existing designs, problems still remain. In particular, the front of the spoon only provides a scraper for flat surfaces, but fails to provide a surface for scraping curved or squared edges such as the inside surfaces of a mixing bowl or the corner of a cake pan.

Similarly, the spoon of U.S. patent application Ser. No. 11/516,903 discloses a spoon having two sides that terminate at a thin, sharp front edge. This front edge is described as a spatula blade. This design is problematic, however, because the spatula blade is concave, not flat. Thus, the blade is not designed for efficient scraping of flat surfaces.

3. Identification of Objects of the Invention

A primary object of the invention is to provide a cooking spoon that overcomes the disadvantages of the prior art.

Another object of the invention is to provide a cooking spoon having one curved surface between the bottom end and one side for scraping curved corners, and one squared surface between the bottom end and another side for scraping squared corners.

Another object of the invention is to provide a cooking spoon having a flat front edge surface for scraping cooking surfaces, both when the spoon is pushed forward or pulled backward along the cooking surface.

Another object of the invention is to provide a cooking spoon having markers in the spoon bowl providing volume measurement marks for ingredients when placed in the bowl.

Another object of the invention is to provide a cooking spoon having mating surfaces smooth creating a transition from the head to the handle.

Still another object of the invention is to provide a cooking spoon made of a material that will absorb impact, forces when the spoon comes into contact with enameled or glass cookware to protect the cookware.

### SUMMARY OF THE INVENTION

The objects identified above along with other features and advantages of the invention are incorporated in a cooking spoon having a head with one curved front corner and one squared front corner at a flat front edge. The shape of the curved front corner conforms in shape to the curved surfaces of some cookware, such as, for example, mixing bowls. The shape of the squared front corner conforms in shape to the square corners of some cookware, such as, for example, casserole dishes or cake pans. The bowl of the cooking spoon may have measuring markers positioned to indicate the quantity of an ingredient held within the bowl. Another aspect of the cooking spoon includes a head having a flat front edge useful for scraping flat cooking surfaces such as sauté pans or other cooking utensils used for stovetop cooking.

In addition, the head of the cooking spoon is made of silicone. Silicone is advantageous for the head construction, because it is soft enough to absorb impact forces when the cooking spoon head strikes an edge of enameled or glass cookware. Thus, the banging of the spoon against an enameled cookware edge, such as to remove material from the head of the spoon, will not likely damage the enamel of the cookware.

Yet another aspect of the invention concerns a continuous smooth transition between the handle and the head of the spoon. The shape of the handle corresponds to the shape of the spoon head at the interface therebetween, such that the profile of the combined components is continuous. The silicone spatula head includes a length of silicone material which extends into a cylindrical end of the handle. The end of the handle with silicone inserted therein is somewhat compliant so that a blow to the handle end against an enameled bowl rim or the like is less damaging to the bowl.

### BRIEF DESCRIPTION OF THE DRAWINGS

The invention will be better understood by reading the detailed description of embodiments which follow and by examining the accompanying drawings, in which:

FIG. 1 is a front view of the cooking spoon according to the invention;

FIG. 2 is a front view of the spoon head according to the invention;

FIG. 3 is a cross-sectional view of the head of the cooking spoon according to the invention taken along lines 3-3 of FIG. 1; and

FIG. 4 is a side view of the cooking spoon according to the invention.

### DESCRIPTION OF A PREFERRED EMBODIMENT OF THE INVENTION

The aspects, features, and advantages of the invention mentioned above are described in more detail by reference to the drawings wherein like reference numerals represent like elements.

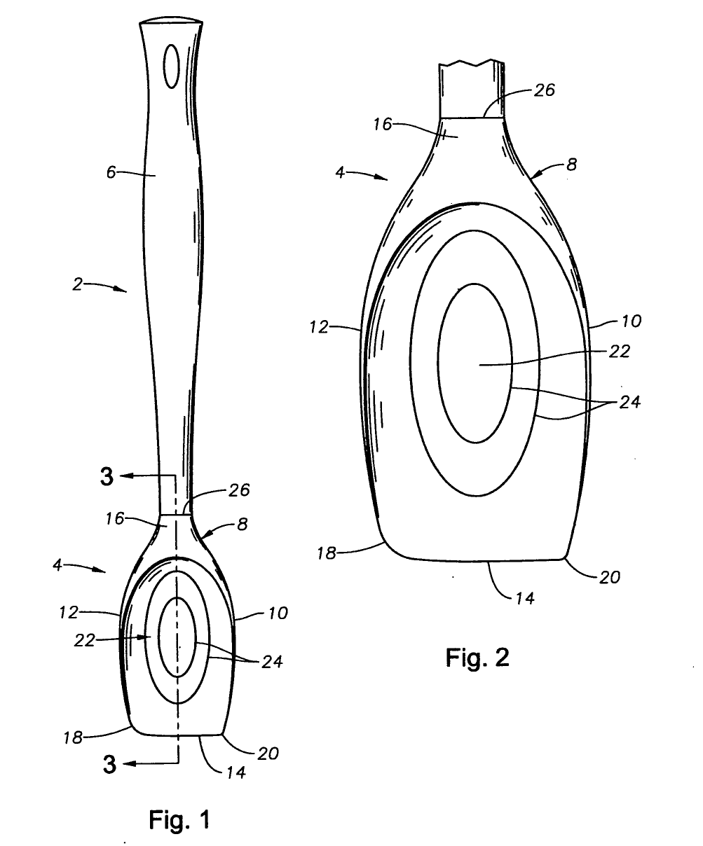

FIG. 1 shows a front view of a cooking spoon 2 of an embodiment of the invention. The cooking spoon 2 has a head 4 and a handle 6. The head 4 has a top end 8, two longitudinal sides 10, 12, and a flat front edge 14. The head 4 also has a handle-receiving portion 16. As can be seen from FIGS. 1 and 2, the front profile of the interface 18 between the longitudinal side 12 and the bottom 14 is curved. On the other side of the flat front edge 14, the front profile of the interface 20 between the longitudinal side 10 and the bottom end 14 is of a square shape. The distal end of the spoon is the front edge 14. The head 4 includes a bowl 22 having measuring marks 24 positioned to indicate the quantity of an ingredient held within the bowl 22. In addition, the handle-receiving portion 16 is made of silicone or other soft material, thereby creating a strike zone to protect cookware when the spoon strikes the cookware for the purpose of removing food materials from the head 4. Furthermore, the interface 26 between the handle 6 and the handle-receiving portion 16 is continuous thereby creating a smooth transition from handle 6 to head 4.

As shown in FIGS. 1 and 2, the curved interface 18 and the squared interface 20 between the distal end and the longitudinal sides 12, 10 respectively creates a dual option front end. Each side of the dual option front end is configured to scrape cookware having a different geometry. For example, the curved interface 18 allows a cook to scrape the rounded contours of mixing bowls, while the squared interface 20 is conducive to scraping the square corners of cake pans or casserole dishes. The flat front edge 14 of the cooking spoon 2 is arranged and designed to facilitate scraping of flat surfaces, such as the bottom of sauté pans. The flat front edge 14 allows for forward scraping of a flat cooking surface, and it also facilitates its use by a cook making a roux. A roux starts with flour and fat, so the back side of the spoon edge 14 can be used in a “pulling” motion to smash bits of flour and facilitates blending them into a smooth paste.

Also shown in FIGS. 1 and 2 are measuring marks 24. Measuring marks 24 are attached or imprinted on the inside surface of the bowl 22 and provide a way to measure volume of ingredients in the bowl 22. As a cook scoops ingredients into the bowl 22 of the spoon 2, the quantity of ingredient can be easily determined by comparison of the volume that the ingredient occupies in the bowl 22 to the nearest measuring mark 24. Thus, the need to use specifically designated measuring spoons in a cooking operation is eliminated or reduced.

The handle-receiving portion 16 of the head 4 is manufactured of an impact resistant material, such as silicone. The portion 16 provides a strike zone. Thus, when a user strikes the spoon 2 against a piece of cookware, such as, for example, to remove food from the head 4 of the spoon 2, the impact of the strike will be absorbed by the handle-receiving portion 16, thereby protecting the cookware and the cooking spoon 2 from damage. The handle-receiving portion 16 generally extends upwardly beyond the top end 8 of the head 4 in order to provide a larger strike zone. The silicone spatula head 4 includes a length of silicone material which extends into a cylindrical opening at the end of the handle 6. The end of the handle with silicone inserted in its end is somewhat compliant so that a blow to the handle end against a bowl rim or the like is less damaging to the bowl.

In addition, the thickness of the head is sufficient to provide substantial rigidity to the cooking spoon 2. The cooking spoon 2 is sturdy enough, for example, to stir and scoop dense ingredients. Similarly, the flat front edge 14 of the cooking spoon 2 is strong enough to crumble hamburger in a sauté pan. The depth of the bowl 22 is also deep enough to permit the scooping of relatively large portions of food. Furthermore, as can be seen in all of the Figures, the shape of the handle-receiving portion 16 of the head 4 matches the shape of the handle 6 at the interface 26 where they intersect, such that the transition between the handle-receiving portion 16 and the handle 6 is smooth and continuous.

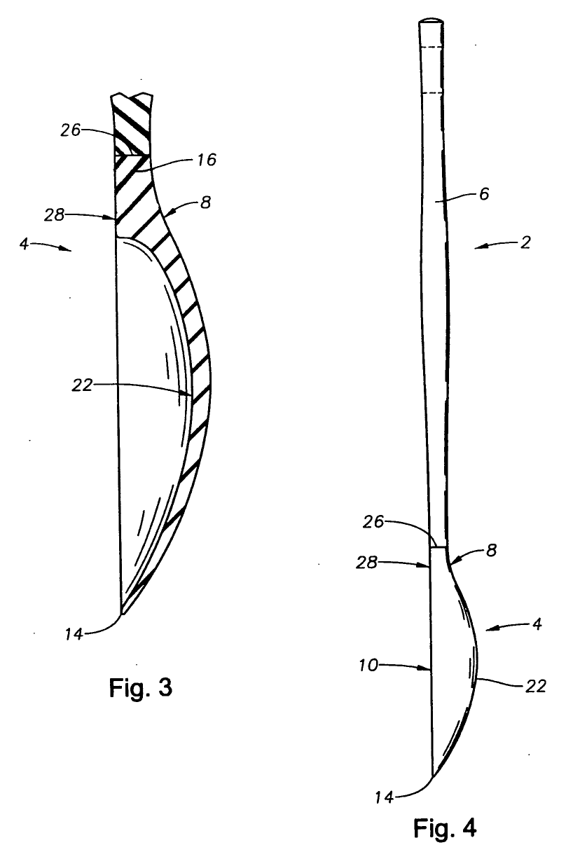

FIG. 3 shows a cross-sectional view of the head 4 of spoon 2 taken along lines 3-3 of FIG. 1. FIG. 4 shows a side view of the spoon 2. As can be seen in these Figures, the flat front edge 14 of the spoon 2 lies along the same plane as the front 28 of the top end 8 of the head 4. The bowl 22 lies between the bottom end 14 and the top end 8 of the head 4. The bowl 22 is concave.

What is claimed is:

1. A cooking spoon (2), comprising:
a bowl (22) having a top end (8) and first and second curved longitudinal sides (12,10);
a flat front edge (14) formed integrally with the bowl (22); and
a handle (6) attached to the top end (8) of the bowl (22);
wherein the bowl (22) merges with the flat front edge (14) and provides a receptacle for material directed thereinto by the flat front edge (14); and
wherein the profile of the interface (18) between the first longitudinal side (12) and the flat front edge (14) has a curved shape and the profile of the interface (20) between the second longitudinal side (10) and the flat front edge (14) has a squared shape.

2. The cooking spoon (2) of claim 1, further comprising
a handle-receiving portion (16) connecting the bowl (22) to the handle (6), and wherein the handle-receiving portion (16) has a cross-section that matches a cross-section of the handle (6), such that an interface (26) between the handle-receiving portion (16) and the handle (6) is smooth and continuous.

3. The cooking spoon (2) of claim 2, wherein
the handle-receiving portion (16) is made of silicone, thereby creating a strike zone for protecting cookware when the cooking spoon (2) impacts cookware at the handle-receiving portion (16).

4. The cooking spoon (2) of claim 1, wherein
the bowl (22) has volume markers (24) placed at predetermined locations thereon to indicate the volume of material placed in the bowl (22).

5. A cooking spoon (2), comprising:
a bowl (22) having a handle-receiving portion (16), a top end (8), and first and second longitudinal sides (12, 10);
a flat front edge (14) formed integrally with the bowl (22); and
a handle (6) attached to the handle-receiving portion (16);
wherein the bowl (22) merges with the flat front edge (14) and provides a receptacle for material directed thereinto by the flat front edge (14);
the handle-receiving portion (16) having a cross-section that matches a cross-section of the handle (6), such that the interface (26) between the handle-receiving portion (16) and the handle (6) is smooth and continuous; and
the profile of the interface (18) between the first longitudinal side (12) and the bottom end (14) is of a curved shape and the profile of the interface (20) between the second side (10) and the bottom (14) is of a square shape.

6. The cooking spoon (2) of claim 5, wherein
the handle-receiving portion (16) is made of silicone, thereby creating a strike zone for protecting cookware when the handle-receiving portion (16) impacts the cookware.

7. The cooking spoon (2) of claim 5, wherein
the bowl (22) has volume markers (24) placed at predetermined locations thereon to indicate the volume of material in the bowl (22).

8. The cooking spoon (2) of claim 5, wherein
the handle-receiving portion (16) includes a length of silicone material which extends into a cylindrical end of the handle 6.
